(19) United States
(12) Patent Application Publication
(10) Pub. No.: US 2021/0061427 A1
(43) Pub. Date: Mar. 4, 2021

(54) BOAT SUPPORT ASSEMBLY

(71) Applicant: Dennis H. WANG, Baldwin Park, CA (US)

(72) Inventor: Dennis H. WANG, Baldwin Park, CA (US)

(21) Appl. No.: 15/931,803

(22) Filed: May 14, 2020

(30) Foreign Application Priority Data
Aug. 27, 2019 (TW) 108130626

(51) Int. Cl. B63C 5/04; B63C 15/00

(52) U.S. Cl. CPC B63C 5/04; B63C 1/10; B63C 15/00

(57) ABSTRACT

A boat support assembly includes a main frame a first connecting strap which is flexible and deformable. A first support is pivotably connected to the main frame. A second support is pivotably connected to the main frame. Pivotal movement between the second support and the main frame is independent from pivotal movement between the first support and the main frame. The first connecting strap is connected to the first support and the second support.

### BACKGROUND OF THE INVENTION

The present invention relates to a support assembly and, more particularly, to a boat support assembly for supporting a boat.

CN 201620127066.1 discloses a telescopic boat support assembly including a main frame, two supporting bottom boards, four supporting rods, an adjusting screw, an adjusting nut, a movable top, and a ball head. The two supporting bottom boards are hinged to a bottom of the main frame. A top end of each of the four supporting rods is welded or detachably connected to a top end of the main frame. A bottom end of each of the four supporting rods is connected to a distal end of a respective one of the two supporting bottom boards. The adjusting screw is welded or detachably connected to the top end of the main frame through the adjusting screw. The adjusting screw is welded or detachably connected to the movable top which is movably mounted on top of the ball head.

The movable top of the above boat support assembly can rotate in any direction through the ball head structure. However, before the boat body is disposed, a supporting face of the movable top must be adjusted to an orientation facing a surface of the boat body. Otherwise, the movable top could be pushed by the boat body to an improper angular position during placement of the boat body, failing to provide a stable supporting effect or an automatic abutting effect.

Thus, a need exists for a novel boat support assembly to overcome the disadvantages of the prior art.

### BRIEF SUMMARY OF THE INVENTION

A boat support assembly according to the present invention includes a main frame a first connecting strap which is flexible and deformable. A first support is pivotably connected to the main frame. A second support is pivotably connected to the main frame. Pivotal movement between the second support and the main frame is independent from pivotal movement between the first support and the main frame. The first connecting strap is connected to the first support and the second support.

In an example, the main frame includes a first vertical rod and a second vertical rod. A first stay and a first collar are disposed on an end of the first vertical rod. The first support is pivotably mounted to an end of the first stay. Another end of the first stay has a first outer threading. The first collar is rotatably mounted to the first vertical rod and includes a first inner threading in threading connection with the first outer threading. A second stay and a second collar are disposed on an end of the second vertical rod. The second support is pivotably mounted to an end of the second stay. Another end of the second stay has a second outer threading. The second collar is rotatably mounted to the second vertical rod and includes a second inner threading in threading connection with the second outer threading.

In an example, the first support includes a first through-hole, and the second support includes a second through-hole. The first connecting strap includes a first end and a second end opposite to the first end. The first connecting strap extends through the first through-hole and the second through-hole. The second end of the first connecting strap is coupled to the first end of the first connecting strap to form a loop.

In an example, the first through-hole is located on a side of the first support adjacent to the second support, and the second through-hole is located on a side of the second support adjacent to the first support.

In an example, the first support includes a first through-hole, and the second support includes a second through-hole. The first through-hole is located on a side of the first support adjacent to the second support. The second through-hole is located on a side of the second support adjacent to the first support. A third support and a fourth support are pivotably mounted to the main frame. Pivotal movement between the third support and the main frame is independent from pivotal movement between the fourth support and the main frame. The third support is identical to the first support and has a through-hole. The fourth support is identical to the second support and has a through-hole. The main frame includes a third vertical rod and a fourth vertical rod. A third stay and a third collar are disposed on an end of the third vertical rod. The third support is pivotably mounted to an end of the third stay. Another end of the third stay has a third outer threading. The third collar is rotatably mounted to the third vertical rod and includes a third inner threading in threading connection with the third outer threading. A fourth stay and a fourth collar are disposed on an end of the fourth vertical rod. The fourth support is pivotably mounted to an end of the fourth stay. Another end of the fourth stay has a fourth outer threading. The fourth collar is rotatably mounted to the fourth vertical rod and includes a fourth inner threading in threading connection with the fourth outer threading. The first connecting strap includes a first end and a second end opposite to the first end. The first connecting strap extends through the first through-hole and the second through-hole. The second end of the first connecting strap is coupled to the first end of the first connecting strap to form a loop. The boat support assembly further includes a second connecting strap which is flexible and deformable. The second connecting strap is connected to the third support and the fourth support. The second connecting strap includes a first end and a second end opposite to the first end. The second connecting strap extends through the through-hole of the third support and the through-hole of the fourth support. The second end of the second connecting strap is coupled to the first end of the second connecting strap to form a loop.

In an example, the first connecting strap includes a first end and a second end opposite to the first end. The first connecting strap extends across a top portion of the first support and a top portion of the second support, extends across a side of the first support opposite to the second support, and extends across a side of the second support opposite to the first support. The first end of the first connecting strap is connected to the first vertical rod. The second end of the first connecting strap is connected to the second vertical rod.

In an example, the first vertical rod includes a first hook. The first end of the first connecting strap is detachably coupled with the first hook. The second vertical rod includes a second hook. The second end of the first connecting strap is detachably coupled with the second hook.

In an example, the first connecting strap includes a first end and a second end opposite to the first end. The first connecting strap extends across a top portion of the first support and a top portion of the second support, extends across a side of the first support opposite to the second support and a bottom portion of the first support, and extends across a side of the second support opposite to the first support and a bottom portion of the second support. The second end of the first connecting strap is coupled to the first end of the first connecting strap to form a loop.

The present invention will become clearer in light of the following detailed description of illustrative embodiments of this invention described in connection with the drawings.

### DESCRIPTION OF THE DRAWINGS

FIG. 1 is a perspective view of a boat support assembly of a first embodiment according to the present invention.

FIG. 2 is a partial, exploded, perspective view of the boat support assembly of FIG. 1 with a first support and a second support detached.

FIG. 3 is a partial, exploded, perspective view of the boat support assembly of FIG. 1 with a third support and a fourth support detached.

FIG. 4 is a cross sectional view of the boat support assembly of FIG. 1.

FIG. 5 is a diagrammatic view illustrating use of the boat support assembly of FIG. 1.

FIG. 6 is a perspective view of a boat support assembly of a second embodiment according to the present invention.

FIG. 7 is a partial, exploded, perspective view of the boat support assembly of FIG. 6 with a first support and a second support detached.

FIG. 8 is a partial, exploded, perspective view of the boat support assembly of FIG. 6 with a third support and a fourth support detached.

FIG. 9 is a perspective view of a boat support assembly of a third embodiment according to the present invention.

### DETAILED DESCRIPTION OF THE INVENTION

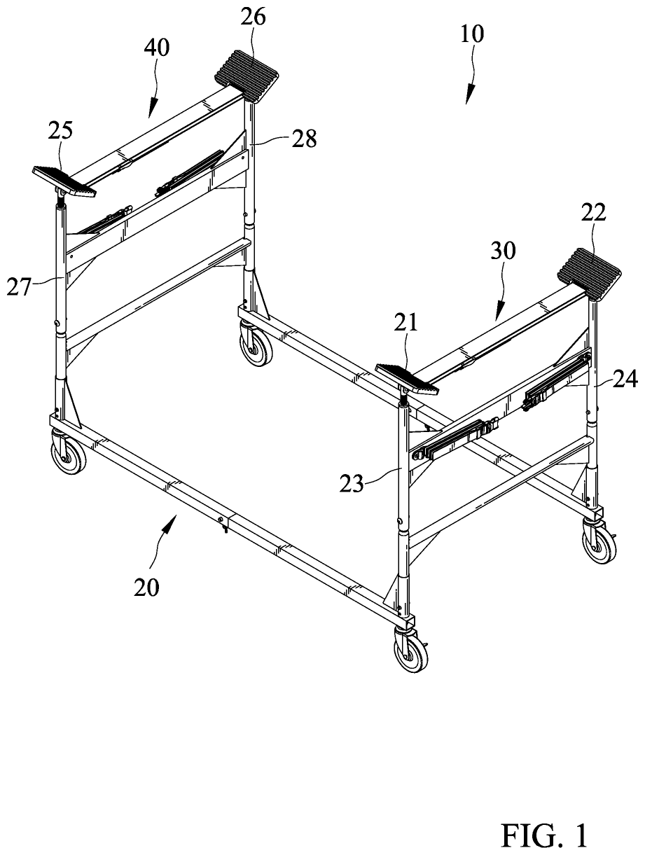

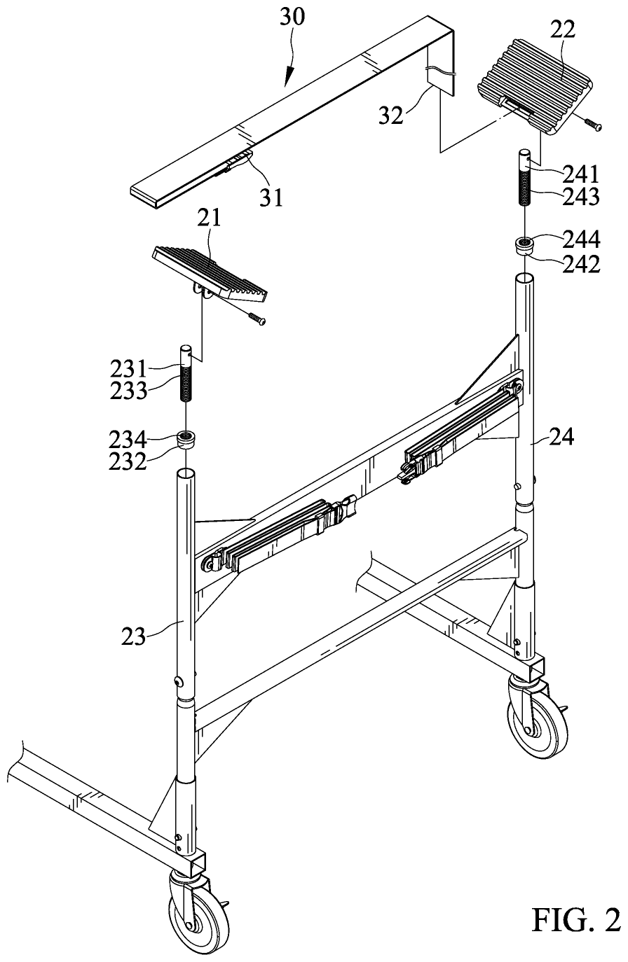

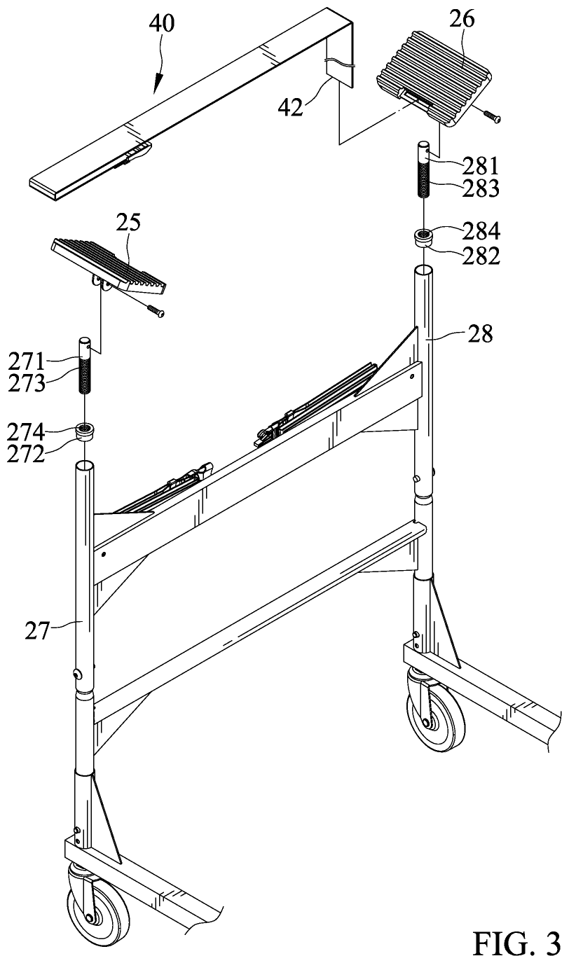

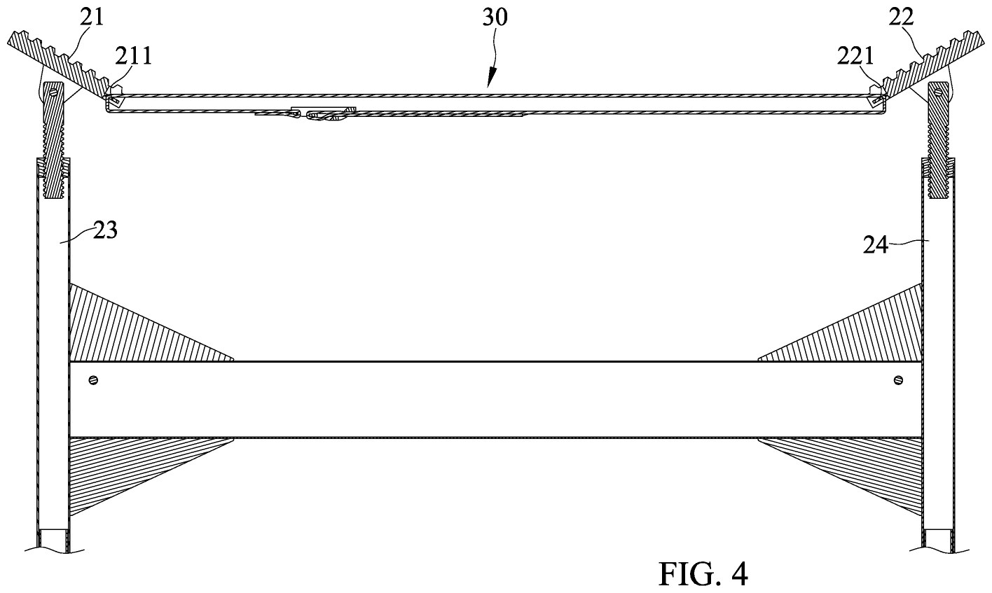

With reference to FIGS. 1-4, a boat support assembly 10 of a first embodiment according to the present invention includes a main frame 20, a first connecting strap 30, and a second connecting strap 40. A first support 21 and a second support 22 are pivotably connected to the main frame 20. Pivotal movement between the second support 22 and the main frame 20 is independent from pivotal movement between the first support 21 and the main frame 20. The first support 21 includes a first through-hole 211 located on a side of the first support 21 adjacent to the second support 22. The second support 22 includes a second through-hole 221 located on a side of the second support 22 adjacent to the first support 21.

The main frame 20 includes s a first vertical rod 23 and a second vertical rod 24. A first stay 231 and a first collar 232 are disposed on an end of the first vertical rod 23. The first support 21 is pivotably mounted to an end of the first stay 231. Another end of the first stay 231 has a first outer threading 233. The first collar 232 is rotatably mounted to the first vertical rod 23 and includes a first inner threading 234 in threading connection with the first outer threading 233. A second stay 241 and a second collar 242 are disposed on an end of the second vertical rod 24. The second support 22 is pivotably mounted to an end of the second stay 241. Another end of the second stay 241 has a second outer threading 243. The second collar 242 is rotatably mounted to the second vertical rod 24 and includes a second inner threading 244 in threading connection with the second outer threading 243.

A third support 25 and a fourth support 26 are pivotably mounted to the main frame 20. Pivotal movement between the third support 25 and the main frame 20 is independent from pivotal movement between the fourth support 26 and the main frame 20. In this embodiment, the third support 25 is identical to the first support 21 and has a through-hole, and the fourth support 26 is identical to the second support 22 and has a through-hole.

The main frame 20 includes a third vertical rod 27 and a fourth vertical rod 28. A third stay 271 and a third collar 272 are disposed on an end of the third vertical rod 27. The third support 25 is pivotably mounted to an end of the third stay 271. Another end of the third stay 271 has a third outer threading 273. The third collar 272 is rotatably mounted to the third vertical rod 27 and includes a third inner threading 274 in threading connection with the third outer threading 273. A fourth stay 281 and a fourth collar 282 are disposed on an end of the fourth vertical rod 28. The fourth support 26 is pivotably mounted to an end of the fourth stay 281. Another end of the fourth stay 281 has a fourth outer threading 283. The fourth collar 282 is rotatably mounted to the fourth vertical rod 28 and includes a fourth inner threading 284 in threading connection with the fourth outer threading 283.

The first connecting strap 30 is flexible and deformable. The first connecting strap 30 is connected to both the first support 21 and the second support 22. The first connecting strap 30 has a first end 31 and a second end 32 opposite to the first end 31. The first connecting strap 30 extends through the first through-hole 211 and the second through-hole 221. The second end 32 of the first connecting strap 30 is coupled to the first end 31 of the first connecting strap 30 to form a loop.

The second connecting strap 40 is flexible and deformable. The second connecting strap 40 is connected to both the third support 25 and the fourth support 26. The second connecting strap 40 includes a first end 41 and a second end 42 opposite to the first end 41. The second connecting strap 40 extends through the through-hole of the third support 25 and the through-hole of the fourth support 26. The second end 42 of the second connecting strap 40 is coupled to the first end 41 of the second connecting strap 40 to form a loop.

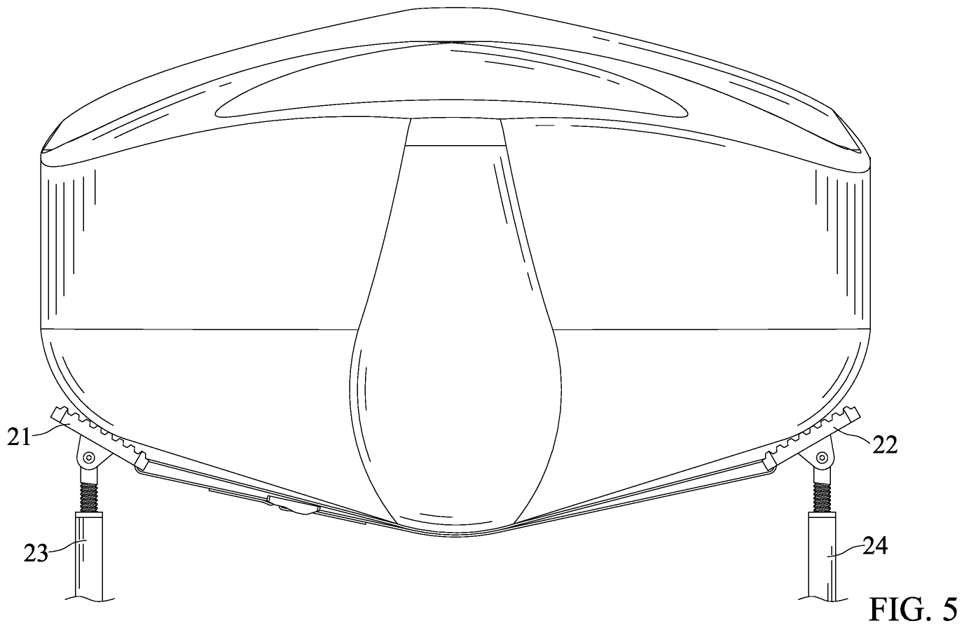

With reference to FIG. 5, in use of the boat support assembly 10 of the first embodiment according to the present invention, the boat support assembly 10 provides a stable, secure supporting effect through the above structure. Since the first support 21 and the second support 22 are pivotable, the angular positions of the first support 21 and the second support 22 can be varied in response to the contour of an outer surface of a boat. Furthermore, since the first connecting strap 30 is connected to both the first support 21 and the second support 22, the boat will contact the first connecting strap 30 first while being placed onto the boat support assembly 10. After the boat presses the first connecting strap 30 downwards, the first connecting strap 30 can change the angular positions of the first support 21 and the second support 22 to assure complete surface contact with between the outer surfaces of the first support 21 and the second support 22 and the outer surface of the boat, enhancing the boat supporting stability of the boat support assembly 10.

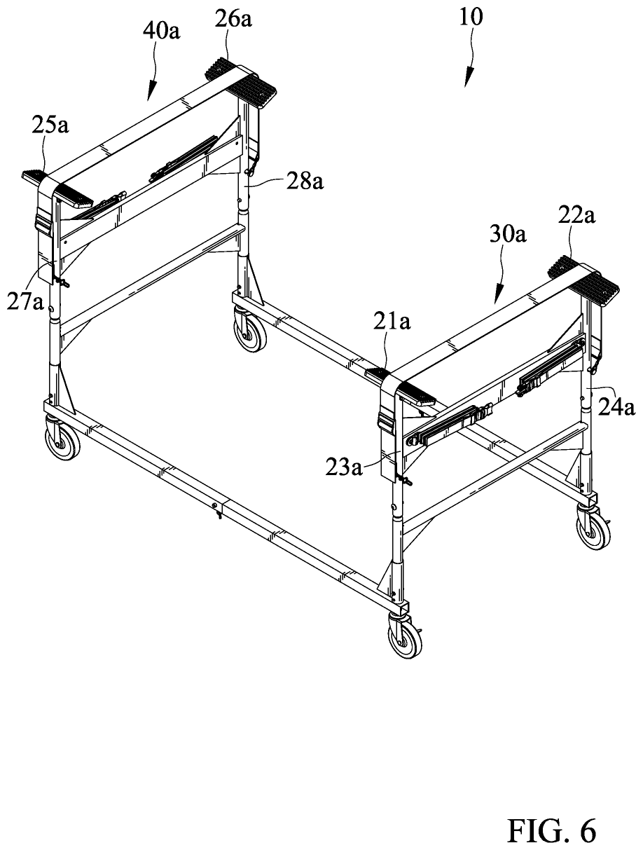

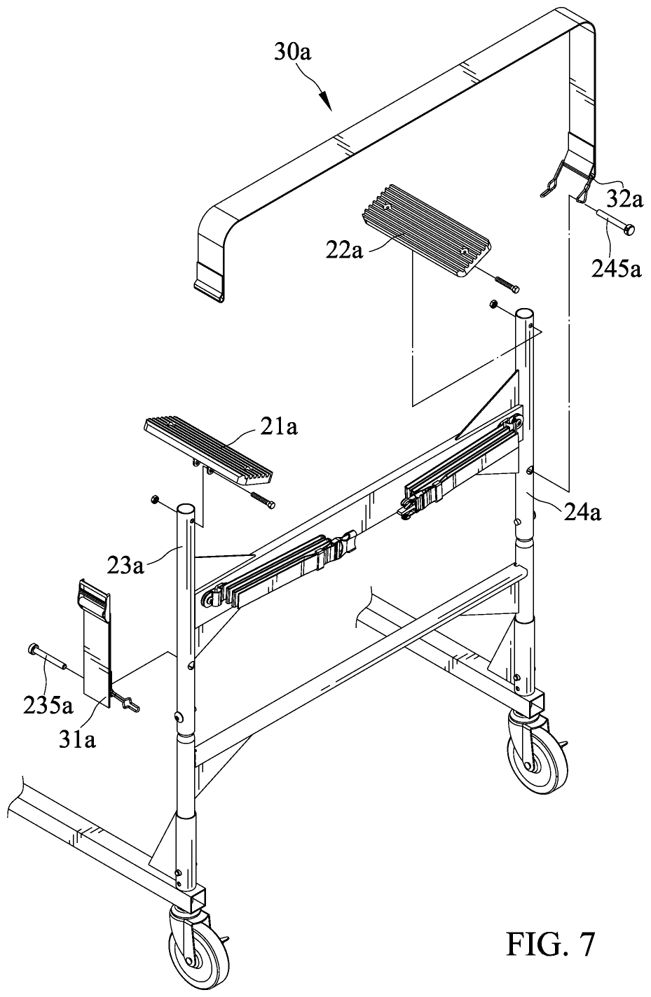

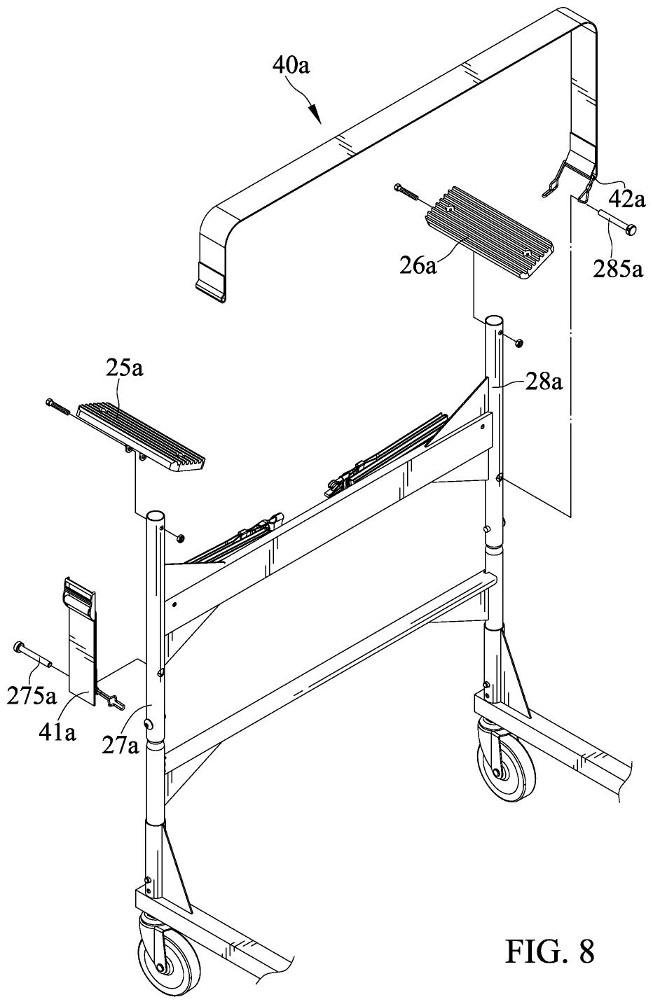

FIGS. 6-8 shows a boat support assembly of a second embodiment according to the present invention. The second embodiment is different from the first embodiment in that the first connecting strap 30a extends across a top portion of the first support 21a and a top portion of the second support 22a, extends across a side of the first support 21a opposite to the second support 22a, and extends across a side of the second support 22a opposite to the first support 21a.

The first end 31a of the first connecting strap 30a is connected to the first vertical rod 23a. The second end 32a of the first connecting strap 30a is connected to the second vertical rod 24a. The first vertical rod 23a includes a first hook 235a. The first end 31a of the first connecting strap 30a is detachably coupled with the first hook 235a. The second vertical rod 24a includes a second hook 245a. The second end 32a of the first connecting strap 30a is detachably coupled with the second hook 245a.

The second connecting strap 40a extends across a top portion of the third support 25a and a top portion of the fourth support 26a, extends across a side of the third support 25a opposite to the fourth support 26a, and extends across a side of the fourth support 26a opposite to the third support 25a.

The first end 41a of the second connecting strap 40a is connected to the third vertical rod 27a. The second end 42a of the second connecting strap 40a is connected to the fourth vertical rod 28a. The third vertical rod 27a includes a third hook 275a. The first end 41a of the second connecting strap 40a is detachably coupled with the third hook 275a. The fourth vertical rod 28a includes a fourth hook 285a. The second end 42a of the second connecting strap 40a is detachably coupled with the fourth hook 285a.

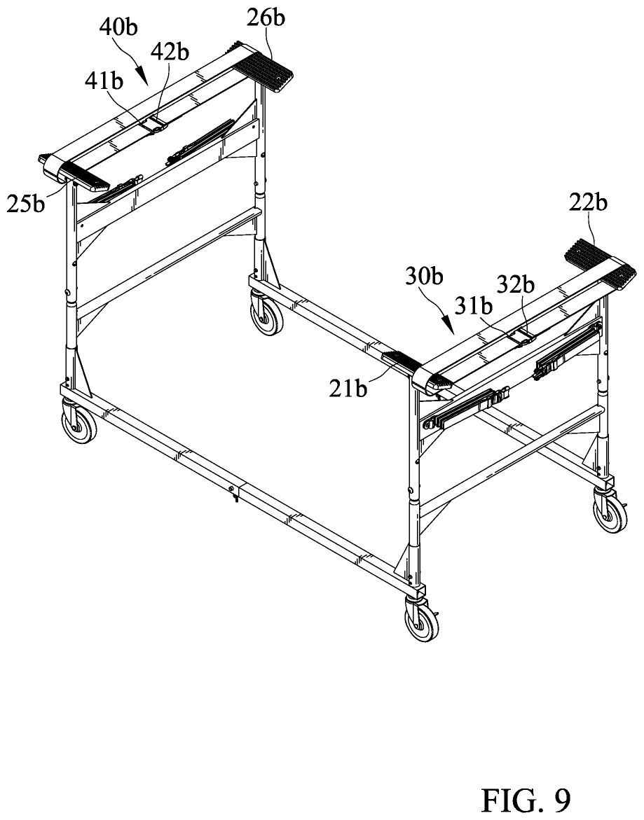

FIG. 9 shows a boat support assembly 10 of a third embodiment according to the present invention. The third embodiment is different from the first embodiment in that the first connecting strap 30b extends across a top portion of the first support 21b and a top portion of the second support 22b, extends across a side of the first support 21b opposite to the second support 22b and a bottom portion of the first support 21b, and extends across a side of the second support 22b opposite to the first support 21b and a bottom portion of the second support 22b. The second end 32b of the first connecting strap 30b is coupled to the first end 31b of the first connecting strap 30b to form a loop.

The second connecting strap 40b extends across a top portion of the third support 25b and a top portion of the fourth support 26b, extends across a side of the third support 25b opposite to the fourth support 26b and a bottom portion of the third support 25b, and extends across a side of the fourth support 26b opposite to the third support 25b and a bottom portion of the fourth support 26b. The second end 42b of the second connecting strap 40b is coupled to the first end 41b of the second connecting strap 40b to form a loop.

In view of the foregoing, the first support 21, 21a, 21b and the second support 22, 22a, 22b can pivot independently, and the first connecting strap 30, 30a, 30b and the second connecting strap 40, 40a, 40b are flexible and deformable and are connected to the first and second supports 21, 21a, 21b and 22, 22a, 22b and the third and fourth supports 27, 27a and 28, 28a. Thus, the boat support assembly 10 according to the present invention can provide a stable, secure supporting effect.

Although specific embodiments have been illustrated and described, numerous modifications and variations are still possible without departing from the scope of the invention. The scope of the invention is limited by the accompanying claims.

1. A boat support assembly comprising:
a main frame;
a first support pivotably connected to the main frame;
a second support pivotably connected to the main frame, wherein pivotal movement between the second support and the main frame is independent from pivotal movement between the first support and the main frame; and
a first connecting strap which is flexible and deformable, wherein the first connecting strap is connected to the first support and the second support.

2. The boat support assembly as claimed in claim 1, wherein the main frame includes a first vertical rod and a second vertical rod, wherein a first stay and a first collar are disposed on an end of the first vertical rod, wherein the first support is pivotably mounted to an end of the first stay, wherein another end of the first stay has a first outer threading, wherein the first collar is rotatably mounted to the first vertical rod and includes a first inner threading in threading connection with the first outer threading, wherein a second stay and a second collar are disposed on an end of the second vertical rod, wherein the second support is pivotably mounted to an end of the second stay, wherein another end of the second stay has a second outer threading, and wherein the second collar is rotatably mounted to the second vertical rod and includes a second inner threading in threading connection with the second outer threading.

3. The boat support assembly as claimed in claim 1, wherein the first support includes a first through-hole, wherein the second support includes a second through-hole, wherein the first connecting strap includes a first end and a second end opposite to the first end, wherein the first connecting strap extends through the first through-hole and the second through-hole, and wherein the second end of the first connecting strap is coupled to the first end of the first connecting strap to form a loop.

4. The boat support assembly as claimed in claim 3, wherein the first through-hole is located on a side of the first support adjacent to the second support, and wherein the second through-hole is located on a side of the second support adjacent to the first support.

5. The boat support assembly as claimed in claim 2, wherein the first support includes a first through-hole, wherein the second support includes a second through-hole, wherein the first through-hole is located on a side of the first support adjacent to the second support, wherein the second through-hole is located on a side of the second support adjacent to the first support, wherein a third support and a fourth support are pivotably mounted to the main frame, wherein pivotal movement between the third support and the main frame is independent from pivotal movement between the fourth support and the main frame, wherein the third support is identical to the first support and has a through-hole, wherein the fourth support is identical to the second support and has a through-hole, wherein the main frame includes a third vertical rod and a fourth vertical rod, wherein a third stay and a third collar are disposed on an end of the third vertical rod, wherein the third support is pivotably mounted to an end of the third stay, wherein another end of the third stay has a third outer threading, wherein the third collar is rotatably mounted to the third vertical rod and includes a third inner threading in threading connection with the third outer threading, wherein a fourth stay and a fourth collar are disposed on an end of the fourth vertical rod, wherein the fourth support is pivotably mounted to an end of the fourth stay, wherein another end of the fourth stay has a fourth outer threading, wherein the fourth collar is rotatably mounted to the fourth vertical rod and includes a fourth inner threading in threading connection with the fourth outer threading, wherein the first connecting strap includes a first end and a second end opposite to the first end, wherein the first connecting strap extends through the first through-hole and the second through-hole, wherein the second end of the first connecting strap is coupled to the first end of the first connecting strap to form a loop, wherein the boat support assembly further includes a second connecting strap which is flexible and deformable, wherein the second connecting strap is connected to the third support and the fourth support, wherein the second connecting strap includes a first end and a second end opposite to the first end, wherein the second connecting strap extends through the through-hole of the third support and the through-hole of the fourth support, and wherein the second end of the second connecting strap is coupled to the first end of the second connecting strap to form a loop.

6. The boat support assembly as claimed in claim 2, wherein the first connecting strap includes a first end and a second end opposite to the first end, wherein the first connecting strap extends across a top portion of the first support and a top portion of the second support, extends across a side of the first support opposite to the second support, and extends across a side of the second support opposite to the first support, wherein the first end of the first connecting strap is connected to the first vertical rod, and wherein the second end of the first connecting strap is connected to the second vertical rod.

7. The boat support assembly as claimed in claim 6, wherein the first vertical rod includes a first hook, wherein the first end of the first connecting strap is detachably coupled with the first hook, wherein the second vertical rod includes a second hook, and wherein the second end of the first connecting strap is detachably coupled with the second hook.

8. The boat support assembly as claimed in claim 1, wherein the first connecting strap includes a first end and a second end opposite to the first end, wherein the first connecting strap extends across a top portion of the first support and a top portion of the second support, extends across a side of the first support opposite to the second support and a bottom portion of the first support, and extends across a side of the second support opposite to the first support and a bottom portion of the second support, and wherein the second end of the first connecting strap is coupled to the first end of the first connecting strap to form a loop.
